(19) United States
(12) Patent Application Publication
(10) Pub. No.: US 2004/0161725 A1
(43) Pub. Date: Aug. 19, 2004

(54) Dental implantation system, support, and related methods

(76) Inventor: Milton A. Clement, Winter Park, FL (US)

Correspondence Address: CHRISTOPHER F. REGAN, ESQUIRE, ALLEN, DYER, DOPPELT,, MILBRATH & GILCHRIST, P.A., P.O. Box 3791, Orlando, FL, 32802-3791, US

(21) Appl. No.: 10/365,769

(22) Filed: Feb. 13, 2003

(51) Int. Cl. A61C 8/00

(52) U.S. Cl. 433/176; 433/173

(57) ABSTRACT

A dental implantation system for securing a dental prosthesis to a patient's alveolar ridge may include a dental implant fixture and a dental implant support. The dental implant fixture may be positioned in the patient's alveolar ridge and have an upper end to receive the dental prosthesis. The dental implant support may connect to the dental implant fixture in a laterally spaced apart relation therefrom and against the alveolar ridge. The dental implant support may include a first support member and a second support member connected to the first support member. The dental implant support may alternately include a support member and connected thereto a loop that extends into the patient's alveolar ridge to receive the dental implant fixture. The dental implant support also may include a fastener extending into the patient's alveolar ridge to connect to the dental implant fixture.

### FIELD OF THE INVENTION

The invention relates to the field of dentistry and, more particularly, to dental implants.

### BACKGROUND OF THE INVENTION

A dental implant can be surgically implanted in a dental patient and a prosthesis mounted on the implant to replace a natural tooth that the patient has lost due to decay or injury. Such a dental prosthesis can be an artificial tooth or crown that affixes to a post that is secured to the patient's alveolar ridge, the bone ridge that forms the borders of the upper and lower jaws and contains the sockets of the patient's teeth.

A frequently observed problem related to the implantation of a dental prosthesis is that when a prosthesis is needed by a patient it usually is needed where the patient has also experienced bone loss or deterioration in the alveolar ridge. When, as a result of disease or injury, bone loss has occurred in or around where a dental prosthesis is needed, it may be that there is not enough bone in which to implant a dental implant fixture in the alveolar ridge.

Conventional devices and methods have sought to address the problem through a succession of surgical procedures. During a first procedure, a support device is used for fostering bone regeneration. For example, U.S. Pat. Nos. 6,238,214 and 5,839,899 to Robinson disclose a plate that snaps onto the head of a screw inserted into the top of a patient's alveolar ridge. The plate is sufficiently flexible to be molded into a tent-like covering over the alveolar ridge to provide a protective space for tissue and bone regeneration. Similarly, U.S. Pat. No. 6,244,868 to Schappert discloses a ring held by an implant in the alveolar ridge and operating to maintain a region in which transplanted bone (taken, for example, from the patient's chin) can grow.

A problem with the conventional devices and methods, however, is that it will generally be another four to eight months from the first procedure before the patient can undergo yet a second surgical procedure to implant the dental implant fixture needed to secure the dental prosthesis to the patient's alveolar ridge. An additional problem is that once the device used in the first procedure to foster bone regeneration is removed, the dental implant fixture to which the prosthesis is attached has no support other than the newly regenerated bone in which it is implanted.

### SUMMARY OF THE INVENTION

With the foregoing background in mind, it is therefore an object of the present invention to provide a system and related methods for more effectively and efficiently providing a dental patient a dental prosthesis.

This and other objects, features, and advantages in accordance with the present invention are provided by a system that may include a dental implant fixture and a dental implant support that connects to the dental implant fixture in a laterally spaced apart relation therefrom. The system provides enhanced support to a dental prosthesis secured to a patient's alveolar ridge. The enhanced support may be provided both during and after a period of bone regeneration in the patient. Moreover, the system may advantageously permit the dental prosthesis to be secured to the patient's alveolar ridge without the need for a first procedure followed by an intervening period of bone regeneration before the patient undergoes yet a second procedure.

The dental implant fixture may be positioned in the patient's alveolar ridge and may have an upper end to receive the dental prosthesis. Positioned against the patient's alveolar ridge and laterally spaced apart from the dental implant fixture, the dental implant support may be connected to the dental implant fixture. The dental implant support, moreover, may include at least one fastener to extend into the patient's alveolar ridge and connect the dental implant support to the dental implant fixture. The dental implant support also may include an end for positioning in an osteotomy in a region of basal bone of the patient's jaw to provide enhanced support.

The dental implant support may include a first support member and a second support member connected to the first support member. Each of the first and second support members may include a plate having openings therein so that regenerated bone may grow through the openings. Each of the first and second support members may include an upper end that connects to the other at a common fold line so that the first and second support members are connected at the common fold line.

The first and second support members may extend outwardly from the common fold line at a desired acute angle relative to one another. The dental implant support may be adjustably bendable at the common fold line. The fastener may include an adjustable fastener that extends through the first and second support members to set the desired angle.

In accordance with another advantageous aspect of the invention, the dental implant support may include a support plate having an upper portion adjustably bendable toward the dental implant fixture to provide support therefor. More particularly, the upper portion may define an upper end of the support plate, and the support plate may be tapered adjacent the upper end. Furthermore, a cross-support may connect the dental implant fixture to the support plate. The cross-support may have a hole therein for receiving the support plate, and the support plate may have a groove formed therein for receiving the cross-support. As such, the dental implant support may further include a wedge to be inserted in the hole for securing the cross-support within the groove.

The dental implant fixture may include a blade-shaped body portion having at least one ridge. The dental implant fixture may include a collar connected to the blade-shaped body portion. In one embodiment, a post may be connected to the collar so that the dental prosthesis may connect to the post. In another embodiment, the collar has a recess therein so that a post may be cemented within the recess so that the dental prosthesis, again, may connect to the post. The recess may have an oval shape. In still other embodiments the dental implant fixture may be generally cylindrical.

Another aspect of the invention relates to a method of implanting a dental prosthesis in a patient. The method may include positioning a dental implant fixture in the patient's alveolar ridge, the dental implant fixture having an upper end to receive the dental prosthesis, and connecting a dental implant support to the dental implant fixture, the dental implant support being in a laterally spaced apart relation from the dental implant fixture and being against the alveolar ridge. For enhanced support, the method may further include positioning an end of the dental implant support within an osteotomy in a region of basal bone of the patient's jaw. Positioning the dental implant and connecting the dental implant support may be performed in a single surgery.

The first and second support members may each have an upper end connected at a common fold line, and the method may include bending the first and second support members relative to one another to form an acute angle. The method may include placing particulate bone within a region between the first and second support members.

### BRIEF DESCRIPTION OF THE DRAWINGS

FIG. 1 is a cross-sectional view of a dental implantation system according to the invention installed in a patient's alveolar ridge.

FIG. 2 is an enlarged perspective view of the dental implant support of the dental implantation system of FIG. 1.

FIG. 3 is a side view of the dental implant fixture of the dental implantation system of FIG. 1.

FIG. 4 is perspective view further illustrating a top portion of the dental implant fixture of FIG. 3.

FIG. 5 is a cross-sectional view of another embodiment of a dental implantation system according to the invention installed in an alveolar ridge.

FIG. 6 is a side view of the dental implant support of the dental implant system illustrated in FIG. 5.

FIG. 7 is a cross-sectional view of yet another embodiment of a dental implantation system according to the invention installed in an alveolar ridge.

FIG. 8 is a cross-sectional view of the dental implant support of the dental implantation system of FIG. 7 before bending of the support plate.

FIG. 9 is flow chart of a method of dental implantation using the dental implantation system illustrated in FIG. 1.

FIG. 10 is flow chart of a method of dental implantation using the dental implantation system illustrated in FIG. 5.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple prime notation are used to indicate similar elements in alternate embodiments.

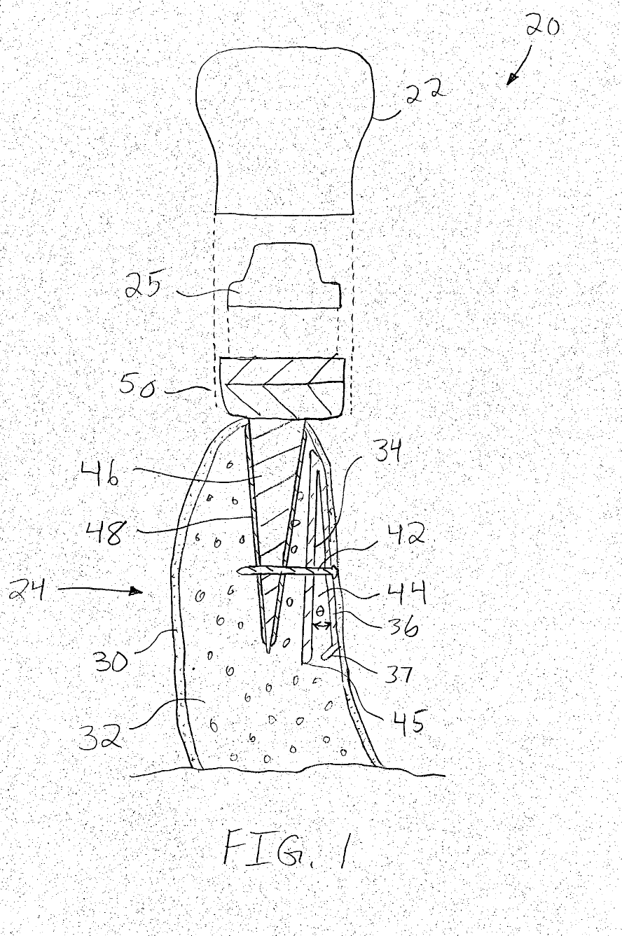

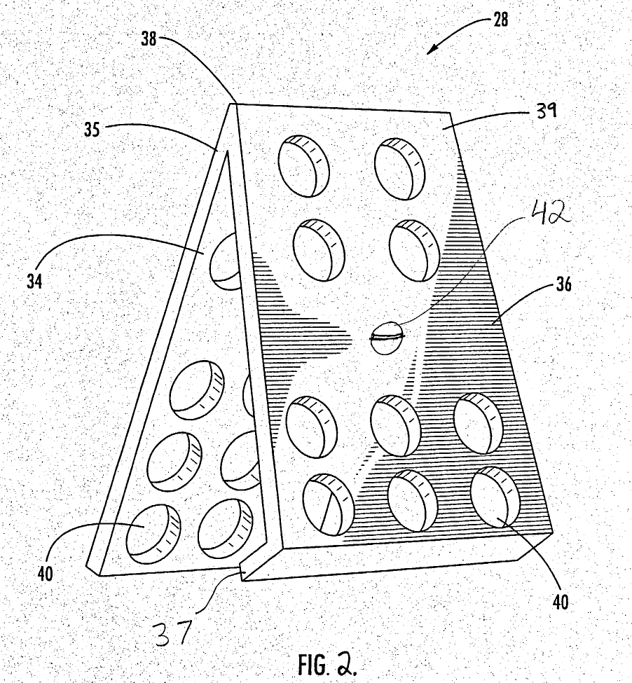

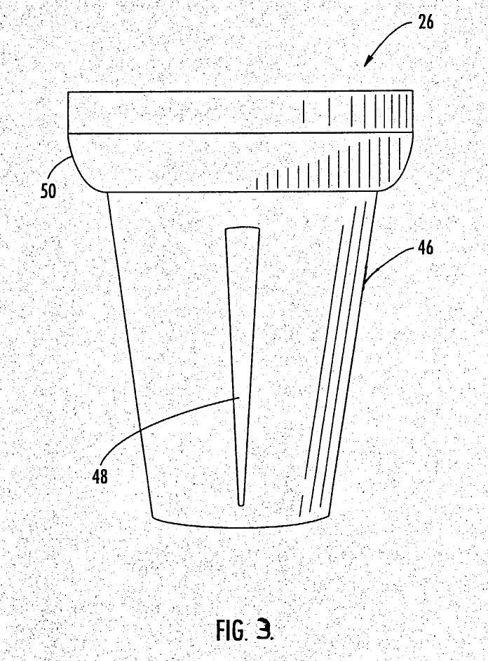

Referring initially to FIGS. 1-4, a dental implantation system 20 for securing a dental prosthesis 22 to a patient's alveolar ridge 24 is described. The dental implantation system 20 includes a dental implant fixture 26 and a dental implant support 28 that connects to the dental implant fixture in a laterally spaced apart relation therefrom The dental implant fixture 26 illustratively extends through the periosteal tissue 30 and into the bone 32 of the patient's alveolar ridge 24. The dental implant support 28 is against the alveolar ridge 24 and laterally spaced apart from the dental implant fixture 26 to which it is connected. For enhanced support, an end 45 of the dental implant support 28 is illustratively positioned within an osteotomy formed in a basal region of the bone 32 at the apex of the alveolar ridge.

Illustratively, a post 25 connects to an upper end of the dental implant fixture 26, and the dental prosthesis 22 fits over the post and is connected thereto. These connections may be made using any suitable dental adhesive, for example, as will be understood by those skilled in the art.

FIG. 1, more particularly, illustrates the condition of the patient's alveolar ridge immediately or very soon after the implantation of the dental implant fixture 26. The dental implant fixture 26 is supported by the dental implant support 28, which is against the portion of bone 32 in the patient's alveolar ridge 24 where significant bone loss has occurred and where support is needed. As explained in detail below, the dental implant support 28 not only supports the dental implant fixture 26 but also facilitates bone regeneration.

The dental implant support illustratively includes a first support member 34 and a second support member 36 connected to the first support member. As illustratively shown, each of the first and second support members 34, 36 is a plate through which a plurality of openings 40 may extend. The openings 40 may be used to promote bone ingrowth, for example. The first and second support members 34, 36 each have respective upper ends 35, 39 that illustratively connect at a common fold line 38. The first and second support members 34, 36 extend outwardly from the common fold line 38 at a desired acute angle θ relative to one another. The dental implant support 28, accordingly, may be adjustably bendable at the common fold line 38.

The dental implant support 28 illustratively includes a fastener 42 to connect the dental implant support to the dental implant fixture 26 in a laterally spaced apart relation. As illustrated, the fastener 42 extends from the dental implant support 28 and into the patient's alveolar ridge 24 to connect to the dental implant fixture 26. As will be readily appreciated by those skilled in the art, the fastener 42 may be an adjustable fastener, such as the illustrated screw, that extends through the first and second support members 34, 36 to set the desired acute angle θ. Of course, other suitable fasteners may be used to connect the dental implant support 28 to the dental implant fixture 26 in a laterally spaced apart relation, as will be readily appreciated by those skilled in the art.

It will further be appreciated that the adjustable fastener 42 can be used to increase and decrease the space 44 between the first and second support members 34, 36. The second support member 36 illustratively includes an inwardly turned lower edge 37 to help maintain the space 44 between the second support member and the first support member 34, although the inwardly turned lower edge need not be included in all embodiments.

In certain applications it may be desirable to insert particulate bone and/or synthetic bone in the space 44 between the first and second support members 34, 36. The dental implant support 28 acts not only to support the dental implant fixture 26 but also provides for bone regeneration. This is a significant advantage because it will often be the case that a patient needing a dental prosthesis will have experienced bone degeneration due to disease or bone loss due to injury in and around the site where the prosthesis is needed. As noted above, the holes 40 may also be used to facilitate bone ingrowth for securing the dental implant support 28.

Because there should be sufficient bone for a dental implant to be successful, previous devices and techniques for implantation typically required that the patient undergo a period of bone regeneration before receiving the dental prosthesis. The dental implantation system 20 of the present invention, however, permits ready securing of the dental prosthesis 22 to the alveolar ridge 24. Implantation of the dental implant fixture 26 therefore can proceed even if the patient has suffered significant bone degeneration. Moreover, fixing of the dental prosthesis 22 may be accomplished in a single surgery rather than in successive surgeries with an intervening period of bone regeneration.

More particularly, the dental implant support 28 provides the support needed for the dental implant fixture 26 so that the dental prosthesis 22 can be readily secured and supported in a single surgical procedure despite the patient's having suffered significant bone loss in the alveolar ridge 24. The dental implant support 28 provides needed support in the region where significant bone loss has occurred while also fostering bone regeneration. Accordingly, the patient can immediately receive a dental prosthesis 22 without waiting an intervening period for bone regeneration.

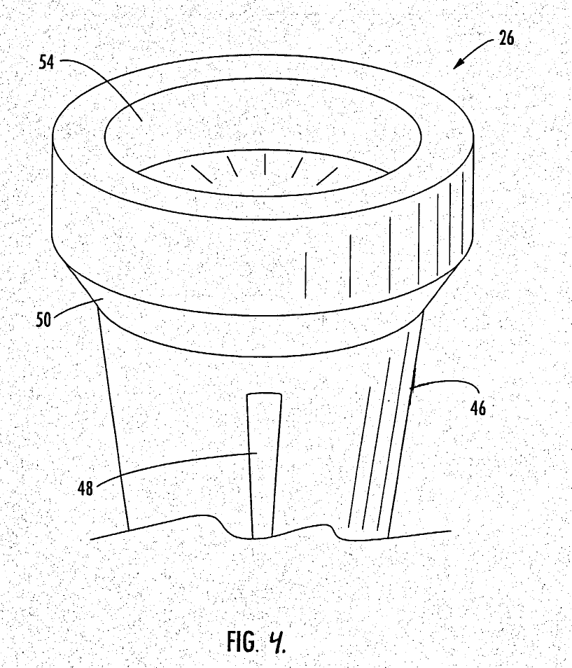

Moreover, even though the patient may have suffered significant bone loss, the dental implant fixture is readily positioned in the patient's alveolar ridge 24 because of its shape. As further illustrated in FIG. 4, the dental implant fixture 26 includes a narrow, blade-shaped body portion 46. The narrow, blade shape permits the body portion 46 to be driven into an osteotomy created in the bone 32 of the patient's alveolar ridge 24.

As illustrated, each surface of the blade-shaped body portion 46 includes a ridge 48 thereon. The ridges 48 are illustratively narrow and positioned on medial portions of the surfaces of the blade-shaped body portion 46. The dental implant fixture 26 can be driven into the osteotomy by tapping its upper end. The tapered shape of the body portion 46 permits the dental implant fixture to be more securely implanted into the patient's alveolar ridge 24.

It follows that the dental implant fixture 26 can therefore be secured in the patient's alveolar ridge 24 without a vertical screw extending through the dental implant fixture into the alveolar ridge as in conventional devices. By obviating the need for such vertical screws, the dental implantation system 20 further reduces the risk of implant failure due to torque caused by an opposing tooth impacting the dental prosthesis (e.g., during chewing), which has been found to be a major contributor to implant failures.

The dental implant fixture 26 further includes a collar 50 connected to a top portion of the blade-shaped body portion 46. With the blade-shaped body portion 46 implanted in the bone 32, the collar 50 is situated above the bone and on the external surface of the periosteal tissue 30 covering the bone. As described above, the collar 50 illustratively connects to a post 25 to which the dental prosthesis 22 may be affixed, thereby securing the dental prosthesis to the patient's alveolar ridge 24.

As best seen in FIG. 4, the collar 50 illustratively has an oval-shaped recess. The post 25 may be received into the recess 54 and cemented therein so that the dental prosthesis, in turn, can be cemented to the post, as will be readily understood by those skilled in the art. One skilled in the art, however, will readily appreciate that the post 25 may alternatively be integrally formed with the collar 50 or otherwise connected to the dental implant fixture 26.

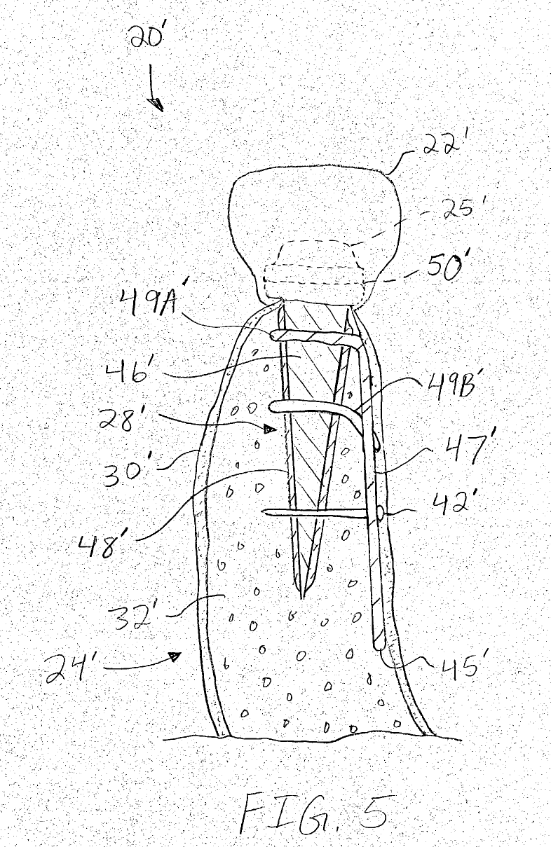

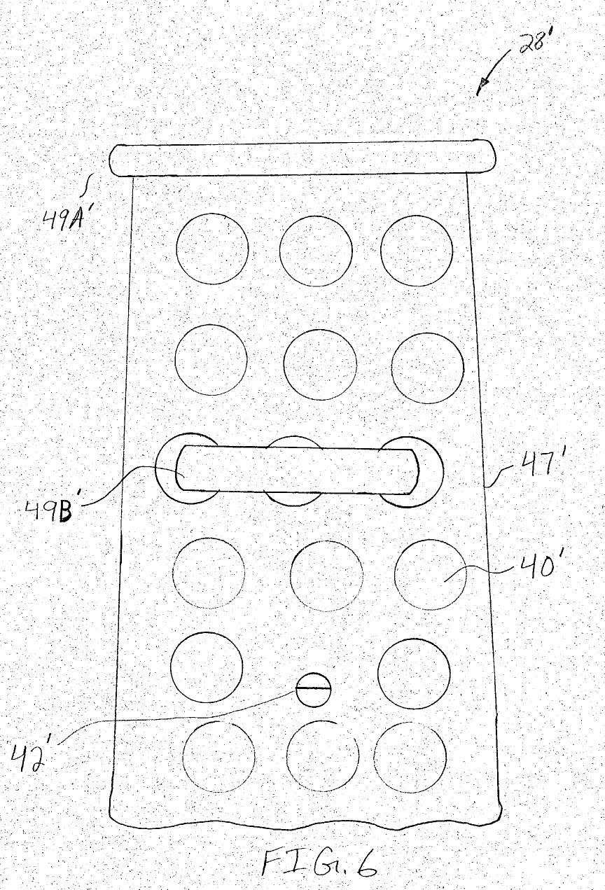

An alternate embodiment of the dental implantation system 20′ is illustrated in FIGS. 5 and 6. It should be noted that the view shown in FIG. 6 is of the right side of the dental implant support 28′ illustrated in FIG. 5. The dental implantation system 20′ illustratively includes a dental implant fixture 26′ and a dental implant support 28′ that connects to the dental implant fixture in a laterally spaced apart relation. The dental implant support 28′ illustratively includes a support member 47′, and, connected to the support member, a pair of loops 49A′, 49B′. Each loop 49A′, 49B′ extends outwardly from the support member so that it may be positioned within the patient's alveolar ridge. Illustratively, the opening of each loop 49A′, 49B′ is perpendicular or nearly perpendicular to the vertical extent of the alveolar ridge such that a portion of the dental implant fixture 26′ extends through the openings.

The dental implant fixture illustratively includes a collar 50′ connected to a body portion 46′. The collar 50′ illustratively connects to a dental prosthesis 22′ as previously described above. The body portion 46′ extends through the periosteal tissue 30′ and into an osteotomy formed in the bone 32′. The body portion 46′ also extends through the pair of loops 49A′, 49B′ within the bone 32′. An end 45′ of the support member 47′ is positioned within another osteotomy, this one formed in the basal region of the bone 32′ at the apex of the alveolar ridge. A fastener 42′ connects the support member 47′ of the dental implant support 28′ to the dental implant fixture 26′ in a spaced apart relation therefrom.

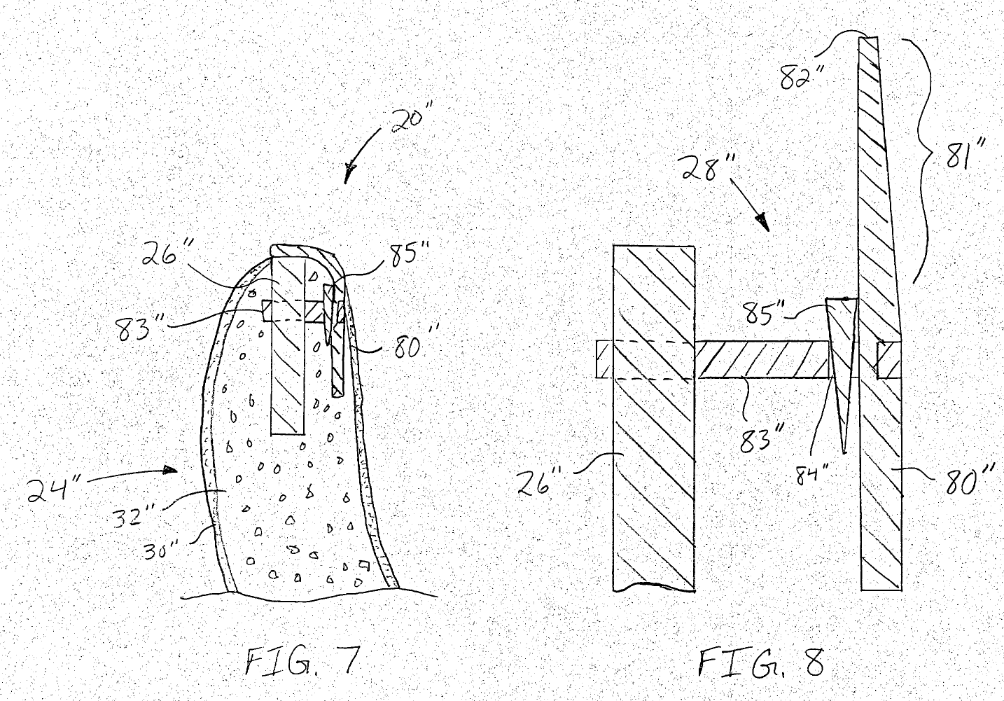

Turning now additionally to FIGS. 7 and 8, another advantageous dental implantation system 20″ is illustratively shown (this time without the collar 50, post 25, or prosthetic 22 for clarity of illustration). It should first be noted that in the illustrated example, a generally cylindrical dental implant fixture 26″ is used instead of the wedge-shaped dental implant fixture 26 described above. Such cylindrical implant fixtures are known in the art and thus will not be described further herein. Yet, it should be noted that other suitable implant fixtures known to those skilled in the art may also be used in accordance with the present invention, and that such implant fixtures may be interchangeably used with the various dental implant supports described herein. It should be noted that the dental implantation system is shown after installation in FIG. 7, and in FIG. 8 it is shown assembled but not installed and before the support plate has been bent.

In the illustrated embodiment, the dental implant support 28″ includes a support plate 80″ having an upper portion 81″ adjustably bendable toward the dental implant fixture 26″ once installed and assembled to provide support for the fixture. More particularly, the upper portion 81″ may be bent over to cover portions of the upper end of the dental implant fixture 26″. This not only holds the fixture 26″ in place, but may also provide additional support and protection for the patient's alveolar ridge 24″ during the healing process and thereafter.

The upper portion 81″ defines an upper end 82″ of the support plate 80″, and the support plate is preferably tapered adjacent the upper end to facilitate bending, for example. Of course, the support plate 80″ need not be tapered in all embodiments. The dental implant support 28″ also illustratively includes a cross-support 83″ which connects the dental implant fixture 26″ to the support plate 80″. The cross-support 83″ not only provides further support for the fixture 26″, but it also helps to promote bone regeneration during the healing process, as will be appreciated by those of skill in the art.

The cross-support 83″ has a hole 84″ therein for receiving the support plate 80″, and the support plate has a groove formed therein for receiving the cross-support, as perhaps best seen in FIG. 8. To secure the cross-support 83″ within the groove of the support plate 80″, the dental implant support 28″ also illustratively includes a wedge 85″ which is inserted in the hole 84, for example, by tapping.

It should be noted that the various components of the dental implant fixtures 26, 26′, 26″ and dental implant supports 28, 28′, 28″ described above have all illustratively been shown as metal components. It will be appreciated by those of skill in the art that other suitable materials may also be used.

An additional aspect of the invention relates to a method of implanting a dental prosthesis in a patient is illustrated in the flow chart 56 of FIG. 8. Illustratively, the method begins (Block 58) with forming a first osteotomy in the bone of the patient's alveolar ridge 24, at Block 60. At Block 62, the dental implant fixture 26 is positioned within the osteotomy formed in the patient's alveolar ridge 24. A second osteotomy is formed (Block 64) in a region of the basal bone at the apex of the alveolar ridge 24. An end 45 of the dental implant support 28 is positioned within the second osteotomy, and the dental implant support 28 is connected to the dental implant fixture in a laterally spaced apart relation and against the alveolar ridge 24 (Block 66).

Illustratively, positioning the dental implant fixture 26 includes inserting the blade-shaped body portion 46 into the osteotomy formed in the patient's alveolar ridge so that the collar extends above periosteal tissue 30 covering the alveolar ridge 24. Connecting the dental implant support 28 and the dental implant fixture 26 illustratively includes inserting a fastener 42 through support members 34, 36 and into the patient's alveolar ridge 24. The method also illustratively includes bending the first and second support members 34, 36 relative to one another to form an acute angle θ (Block 68). Illustratively, the method further includes placing particulate bone and/or synthetic bone within the region between the first and second support members 34, 36 positioned at a desired acute angle θ to one another, at Block 70.

At Block 72 a post 25 is connected to an upper end of the dental implant fixture 26. Illustratively, the method includes affixing (e.g., with cement) the post 25 in a recess 54 in a collar 50 of the dental implant fixture 26. The dental prosthesis 22 is connected to the post at Block 74, thus concluding the illustrated method (Block 76). It will be readily envisioned by those skilled in the art that other techniques can also be employed in connecting the dental prosthesis 22 to the dental implant fixture 26.

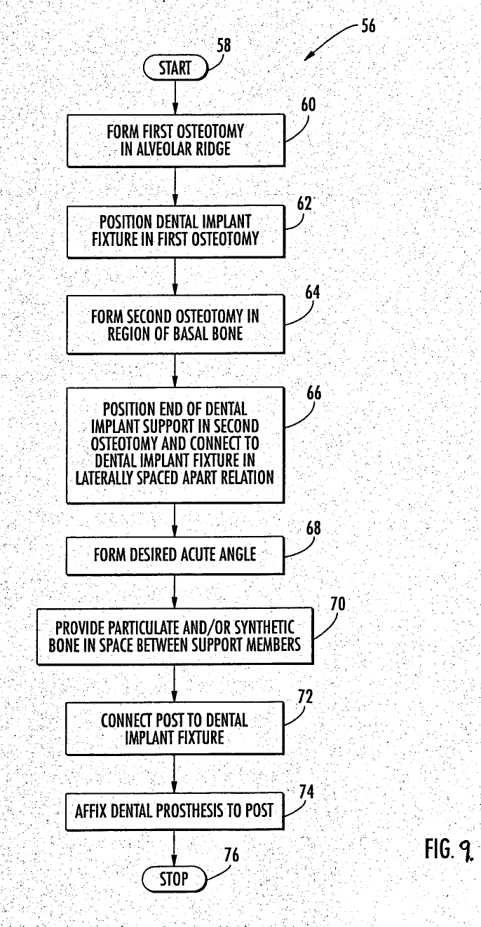

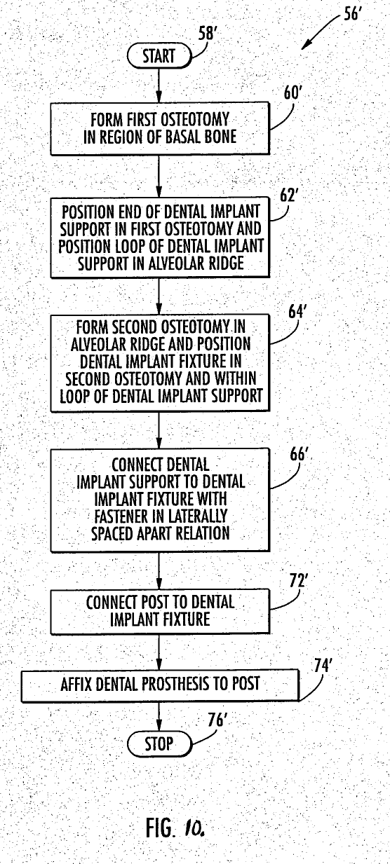

An alternate method of implanting a dental prosthesis in a patient is illustrated by the flow chart 56′ of FIG. 9. Illustratively, the method begins (Block 58′) with forming an osteotomy in the basal region of the bone 32′ at the apex of the patient's alveolar ridge 24′ (Block 60′). At Block 62′, an end 45′ of a support member 47′ of a dental implant support 28′ is positioned in the osteotomy, and loops 49A′, 49B′ of the support member are positioned within the alveolar region of the bone 32′ of the alveolar ridge 24′.

A dental implant fixture 26′ is positioned within another osteotomy in the alveolar bone 32′ such that a body portion 46 of the dental implant fixture is within the loops 49A′, 49B′ of the dental implant support 28′ (Block 64′). At Block 66′, the support member 47′ of the dental implant support 28′ is connected with a fastener 42′ to the dental implant fixture 26′. A post is connected to a collar 50′ of the dental implant fixture at Block 72′, and a dental prosthesis 22′ is affixed to the post at Block 74′, thus concluding the illustrated method (Block 76′). Additional method aspects of the invention will be readily apparent to those skilled in the art in view of the foregoing and will therefore not be discussed further herein.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

That which is claimed is:

1. A dental implantation system for securing a dental prosthesis to a patient's alveolar ridge, the dental implantation system comprising:
a dental implant fixture to be positioned in the patient's alveolar ridge and having an upper end to receive the dental prosthesis; and
a dental implant support to be connected to said dental implant fixture in a laterally spaced apart relation therefrom and against the alveolar ridge.

2. A dental implantation system according to claim 1 wherein said dental implant support comprises at least one fastener to extend into the patient's alveolar ridge and connect said dental implant support to said dental implant fixture.

3. A dental implantation system according to claim 1 wherein said dental implant support comprises a support member and at least one loop connected thereto that extends into the patient's alveolar ridge to receive said dental implant fixture.

4. A dental implantation system according to claim 1 wherein said dental implant support comprises a first support member and a second support member connected to said first support member.

5. A dental implantation system according to claim 4 wherein said second support member comprises an inwardly turned lower edge.

6. A dental implantation system according to claim 4 wherein each of said first and second support members comprises a plate having openings therein.

7. A dental implantation system according to claim 4 wherein upper ends of said first and second support members are connected together at a common fold line and extend outwardly therefrom at a desired acute angle relative to one another.

8. A dental implantation system according to claim 7 wherein said dental implant support is adjustably bendable at said common fold line.

9. A dental implantation system according to claim 1 wherein said dental implant fixture comprises a blade-shaped body portion and a collar connected to said blade-shaped body portion, said collar having a recess formed therein.

10. A dental implantation system according to claim 9 wherein the recess has an oval shape.

11. A dental implantation system according to claim 1 wherein said dental implant support comprises a support plate having an upper portion adjustably bendable toward said dental implant fixture to provide support therefor.

12. A dental implantation system according to claim 11 wherein the upper portion defines an upper end of said support plate, and wherein said support plate is tapered adjacent the upper end.

13. A dental implantation system according to claim 1 wherein said dental implant support comprises:
a support plate laterally spaced apart from said dental implant fixture; and
a cross-support connecting said dental implant fixture to said support plate.

14. A dental implantation system according to claim 13 wherein said cross-support has a hole therein for receiving said support plate; wherein said support plate has a groove formed therein for receiving said cross-support; and wherein said dental implant support further comprises a wedge to be inserted in the hole for securing the cross-support within the groove.

15. A dental implantation system according to claim 1 wherein said dental implant support comprises an end for positioning in an osteotomy in a region of basal bone of the patient's jaw.

16. A dental implantation system according to claim 1 wherein said dental implant fixture is generally cylindrical.

17. A dental implantation system for securing a dental prosthesis to a patient's alveolar ridge, the dental implantation system comprising:
a dental implant fixture to be positioned in the patient's alveolar ridge and having an upper end to receive the dental prosthesis; and
a dental implant support to be connected to said dental implant fixture in a laterally spaced apart relation therefrom, said dental implant support comprising
a first support member to connect to the dental implant fixture in a laterally spaced apart relation therefrom and against the patient's alveolar ridge,
a second support member connected to said first support member, and
a fastener to extend into the patient's alveolar ridge and connect said dental implant support to said dental implant fixture.

18. A dental implantation system according to claim 17 wherein said second support member comprises an inwardly turned lower edge.

19. A dental implantation system according to claim 17 wherein each of said first and second support members comprises a plate having openings therein.

20. A dental implantation system according to claim 17 wherein said first and second support members comprise upper ends that are connected together at a common fold line, said first and second support members extending outwardly from one another at a desired acute angle; and wherein said fastener comprises an adjustable fastener to set the desired acute angle.

21. A dental implantation system according to claim 17 wherein said dental implant fixture comprises a blade-shaped body portion and a collar connected to said blade-shaped body portion, said collar having a recess therein.

22. A dental implantation system for securing a dental prosthesis to a patient's alveolar ridge, the dental implantation system comprising:
a dental implant fixture to be positioned in the patient's alveolar ridge and having an upper end to receive the dental prosthesis; and
a dental implant support to be connected to said dental implant fixture in a laterally spaced apart relation therefrom, said dental implant support comprising
a support member to connect to the dental implant fixture in a laterally spaced apart relation therefrom and against the patient's alveolar ridge,
at least one loop connected to said support member to extend therefrom into the patient's alveolar ridge to receive said dental implant fixture.

23. A dental implantation system according to claim 22 wherein said support member comprises a plate having openings therein.

24. A dental implantation system according to claim 22 wherein said support member comprises an end for positioning in an osteotomy in a region of basal bone of the patient's jaw.

25. A dental implantation system for securing a dental prosthesis to a patient's alveolar ridge, the dental implantation system comprising:
a dental implant fixture to be positioned in the patient's alveolar ridge and having an upper end to receive the dental prosthesis; and
a dental implant support to be connected to said dental implant fixture in a laterally spaced apart relation therefrom and against the alveolar ridge, said dental implant support comprising
a support plate having an upper portion adjustably bendable toward said dental implant fixture to provide support therefore, and
a cross-support connecting said dental implant fixture to said support plate.

26. A dental implantation system according to claim 25 wherein the upper portion defines an upper end of said support plate, and wherein said support plate is tapered adjacent the upper end.

27. A dental implantation system according to claim 25 wherein said cross-support has a hole therein for receiving said support plate; wherein said support plate has a groove formed therein for receiving said cross-support; and wherein said dental implant support further comprises a wedge to be inserted in the hole for securing the cross-support within the groove.

28. A dental implantation system according to claim 25 wherein said support plate has a lower end for positioning in an osteotomy in a region of basal bone of the patient's jaw.

29. A dental implantation system according to claim 25 wherein said dental implant fixture is generally cylindrical.

30. A dental implant support for supporting a dental implant fixture implanted in a patient's alveolar ridge, the dental implant support comprising:
a first support member to connect to the dental implant fixture in a laterally spaced apart relation therefrom and against the patient's alveolar ridge;
a second support member connected to said first support member; and
a fastener to extend into the patient's alveolar ridge and connect said dental implant support to said dental implant fixture implanted therein.

31. A dental implant support according to claim 30 wherein each of said first and second support members comprises a plate having openings formed therein.

32. A dental implant support according to claim 30 wherein said first and second support members comprise upper ends that are connected together at a common fold line, said first and second support members extending outwardly from one another at a desired acute angle.

33. A dental implant support according to claim 30 wherein said second support member comprises an inwardly turned lower edge.

34. A dental implant support for supporting a dental implant fixture implanted in a patient's alveolar ridge, the dental implant support comprising:
a support member to connect to the dental implant fixture in a laterally spaced apart relation therefrom and against the patient's alveolar ridge; and
at least one loop connected to said support member to extend therefrom into the patient's alveolar ridge to receive said dental implant fixture.

35. A dental implant support according to claim 34 wherein said support member comprises a plate having openings therein.

36. A dental implant support according to claim 34 wherein said support member comprises an end for positioning in an osteotomy in a region of basal bone of the patient's jaw.

37. A dental implant support for supporting a dental implant fixture implanted in a patient's alveolar ridge, the dental implant support comprising:
a support plate having an upper portion adjustably bendable toward said dental implant fixture to provide support therefore; and
a cross-support connecting said dental implant fixture to said support plate.

38. A dental implant support according to claim 37 wherein the upper portion defines an upper end of said support plate, and wherein said support plate is tapered adjacent the upper end.

39. A dental implant support according to claim 37 wherein said cross-support has a hole therein for receiving said support plate; wherein said support plate has a groove formed therein for receiving said cross-support; and wherein said dental implant support further comprises a wedge to be inserted in the hole for securing the cross-support within the groove.

40. A dental implant support according to claim 37 wherein said support plate has a lower end for positioning in an osteotomy in a region of basal bone of the patient's jaw.

41. A method of implanting a dental prosthesis in a patient, the method comprising:
positioning a dental implant fixture in the patient's alveolar ridge, the dental implant fixture having an upper end to receive the dental prosthesis; and
connecting a dental implant support to the dental implant fixture in laterally spaced apart relation therefrom and against the alveolar ridge.

42. A method according to claim 41 wherein positioning the dental implant and connecting the dental implant support are performed in a single surgery.

43. A method according to claim 41 wherein the dental support comprises a support member and at least one loop connected thereto; and wherein the method further comprises positioning the at least one loop in the patient's alveolar ridge to receive said dental implant fixture.

44. A method according to claim 41 wherein the dental support comprises a first support member and a second support member each having an upper end connected at a common fold line; and wherein the method further comprises bending the first and second support members relative to one another to form an acute angle.

45. A method according to claim 44 wherein the first and second support members each comprise a plate having openings formed therein.

46. A method according to claim 45 wherein connecting comprises inserting a fastener through each of the support members and into the patient's alveolar ridge to connect to the dental implant fixture positioned therein.

47. A method according to claim 46 further comprising placing at least one of particulate bone and synthetic bone within a region between the first and second support members.

48. A method according to claim 41 wherein the dental implant fixture comprises a blade-shaped body portion having at least one ridge and a collar connected to said blade-shaped body portion; and
wherein positioning comprises inserting the blade-shaped body portion into an osteotomy formed in the patient's alveolar ridge and causing the at least one ridge to expand therein and the collar to extend above periosteal tissue covering the alveolar ridge.

49. A method according to claim 48 wherein the collar has a recess therein; and wherein the method further comprises cementing a post within the recess and connecting the dental prosthesis to the post.

50. A method according to claim 41 wherein the dental implant support comprises a support plate;
and further comprising bending an upper portion of the support plate toward the dental implant fixture to provide support therefor.

51. A method according to claim 50 wherein the upper portion defines an upper end of the support plate, and wherein the support plate is tapered adjacent the upper end.

52. A method according to claim 41 wherein the dental implant support comprises a support plate, and wherein connecting comprises connecting the dental implant fixture to the support plate using a cross-support.

53. A method according to claim 52 wherein the cross-support has a hole therein for receiving the support plate; wherein the support plate has a groove formed therein for receiving the cross-support; and wherein connecting further comprises inserting a wedge in the hole to secure the cross-support within the groove.
